(19) United States
(12) Patent Application Publication
(10) Pub. No.: US 2025/0153907 A1
(43) Pub. Date: May 15, 2025

(54) RECEPTACLE HAVING A RECLOSEABLE LID

(71) Applicant: PAPACKS SALES GMBH, KOELN (DE)

(72) Inventor: Tahsin Dag, Koeln (DE)

(73) Assignee: PAPACKS SALES GMBH, KOELN (DE)

(21) Appl. No.: 18/840,602

(22) PCT Filed: Feb. 17, 2023
(86) PCT No.: PCT/EP2023/054003

§ 371 Date: Aug. 22, 2024

(30) Foreign Application Priority Data
Feb. 25, 2022 (DE) 10 2022 104 645.1

(51) Int. Cl. B65D 43/16; B65D 65/42; B65D 65/46

(52) U.S. Cl. CPC B65D 43/168; B65D 65/42; B65D 65/466

(57) ABSTRACT

The invention relates to a receptacle with a container (1) having at least one opening (2) and a lid (5) for closing the opening (2), which is connected to the container (1) via an elastically deformable hinge.

In order to provide an environmentally safe receptacle, the container (1) is made of fiber material and has a biodegradable or bioinert coating, wherein the lid (5) is made of biodegradable thermoplastic material and a flexible hinge strip (6′) of fiber material attached to the lid (5) is bonded to the container (1).

### TECHNICAL FIELD

The invention relates to a receptacle with a container having at least one opening and a lid for closing the opening, which lid is connected to the container by an elastically deformable hinge.

### BACKGROUND ART

Such containers made of plastic are often used to package liquid products or similar pourable goods. They are made of plastic, with the recloseable lid of the container usually being molded onto a screwed-on lid holder via a film hinge. The lid holder is screwed or snap-fit to the container. EP 2 050 685 A1 describes a receptacle, namely a child-resistant vial, comprising a hollow cylindrical container having a circumferential wall and an opening at one end, wherein as a first connection element a ring is arranged on the circumferential wall of the hollow cylindrical container, which is connected to a lid via a film hinge. The connection element, film hinge and lid are made of polymer material.

It is well known that plastic packaging containers give cause for concern because plastic is impossible or very difficult to biodegrade and pollutes the environment and the oceans.

Harmless packaging made of molded fiber is also known. In English, these containers are called pulp mold containers and are formed from pulp in a suction mold. Water is sucked out of the pulp via the suction mold, whereby pulp fibers present in the pulp are deposited on the wall of the suction mold. The container formed in this way is dewatered and can be used for packaging liquids and bulk materials. EP 1 221 413 A1 describes the manufacture of such a molded fiber container. However, no recloseable lid hinged to the container is disclosed here.

Of course, molded fiber containers with a hinged lid are also known (compare DE 16 11 944 B1). However, egg cartons are described here, which are not liquid-tight and therefore cannot hold liquids or fine-grained powders. GB 2 420 265 A describes a one-piece biodegradable drinking container with a cup section and an integral lid, which is connected to the cup section via a film hinge made of biodegradable material.

### SUMMARY OF INVENTION

The object of the invention is to provide a biodegradable container that is easy to handle and safely stores liquids and pourable materials received therein.

According to the invention, this task is solved in that the container is made of fiber material and has a biodegradable or bioinert coating, that the lid is made of biodegradable thermoplastic material, and that a flexible hinge strip of fiber material attached to the lid is bonded to the container.

Thus, a molded fiber container is proposed that has a biodegradable or bioinert coating so that the container cannot pollute the environment. Biodegradable coatings are usually natural coatings such as lipids, oils or waxes. Bioinert are, for example, coatings containing silicon dioxide. It is further proposed that the lid be made of biodegradable thermoplastic material. Thermoplastic material is particularly suitable for making a container cover. It can be easily and safely processed in large quantities by injection molding. The technology is ideally suited for mass production.

Such a biodegradable thermoplastic may in particular comprise starch and, as further constituents, glycerol and sorbitol as plasticizers. In particular, 11-15 wt % glycerol and 6-9 wt % sorbitol in relation to the total weight of the material in the dried state have proven to be advantageous. In this case, the concentration of starch is between 56 and 63 wt %. Other constituents may be fillers in concentrations of 16-24 wt %. The fillers may be talc, chalk, bentonite, mustard seed husks, organic fibers or waste materials. This material can be excellently processed in twin-screw extruders and injection molded. It can be made moisture resistant and with considerable hardness by applying appropriate coatings. However, this material is usually too brittle to be used as a flexible film hinge to connect the recloseable lid to the container. For this reason, the lid is attached with a flexible hinge strip made of fiber material and bonded to the container.

Such a hinge strip may be made of paper, especially kraft paper. The hinge strip has considerable strength. Appropriate coatings may be used to make the hinge strip moisture-resistant. The hinge strip may be decoratively printed. Consequently, the hinge strip combines the technically required features of flexibility, so that the lid can be opened and closed multiple times, with positive aesthetic features. The fiber material of the hinge strip is biodegradable, even when coated to be moisture-resistant. Consequently, the recloseable packaging with the lid attached by a hinge is harmless to the environment and meets the highest functional and aesthetic requirements.

In practice, the container may have a connection element made of biodegradable thermoplastic material in the area of its opening, the hinge strip being bonded to the container in the area of the connection element. A thermoplastic connection element may be provided at the opening of the molded fiber container to stabilize the opening. Said connection element may be bonded to the molded fiber material of the container or otherwise connected by substance bonding or form-fitting. The lid may be bonded to this connection element by means of the hinge strip, wherein a circular projection of the lid can fit into an annular opening of the connection element. Preferably, cooperating projections and recesses are arranged on the connection element and on the lid, which allow a snap connection or snap-in connection of the lid and the connection element. In this way, the ratio can be securely closed, with the lid being retained on the connection element via the hinge strip in the open state as well.

In practice, the hinge strip may be bonded to the lid. However, it is also possible for the hinge strip to be connected to the lid in some other way. In particular, the lid may be rotatably attached to the hinge strip. This is particularly useful in cases where the lid can be screwed to the connection element.

In practice, the hinge strip may have at least a second section bonded to the container, the second section forming a seal section and being perforated so that it is separated along the perforation when the lid is opened. This seal section serves as a tamper-evident seal. The unseparated perforation allows a purchaser to see that the product within the container is in its original packaging. An opened container can be easily distinguished from an unopened container by the destruction of the perforation.

As mentioned further above, the container may have an external thread in the area of the opening and the lid may have an internal thread that may be screwed onto the external thread. In this case, the hinge strip is rotatably connected to the lid. To achieve a rotatable connection, the hinge strip may have an eyelet formed thereon through which a section of the lid having a circular cross-section extends. For example, a T-shaped pin may be formed on top of the lid and surrounded by the eyelet. Either the hinge strip has some elasticity such that it can be pulled over the periphery of the T-shaped pin and elastically contract. Or alternatively, the T-shaped pin is first inserted through the eyelet and then connected to the lid by form-fitting or substance bonding.

To increase the tightness of the container, the coating may contain at least one of the following constituents:
cellulose fibers,
casein,
whey,
agar agar,
psyllium husks
SiO₂,
linseed oil,
carnauba wax,
beeswax.

Cellulose fibers, especially very short microfibrils, are suitable for increasing the tightness and gas impermeability of the container. Fillers and swelling natural constituents such as casein whey, agar agar and psyllium husks also increase the tightness. Silicon oxide gives the container considerable strength.

Lipids such as oils and waxes also increase the gas and liquid resistance of the container material. All the selected constituents are biodegradable or bioinert, so that the container according to the invention decomposes after a short time without leaving any harmful residues.

As mentioned, the thermoplastic material of the lid is also biodegradable, in particular water-soluble and/or compostable. Such properties may be achieved with the starch-based thermoplastics described above.

The connection element may be connected to the container by substance bonding or also by form-fitting. The thermoplastic material may develop adhesive properties by wetting with water or a solvent and be bonded to the fiber material of the container. It is also possible for the connection element to have a thin connecting wall that is provided with holes. The connecting wall is kept close to the wall of the suction mold during the manufacturing process for the molded fiber container, so that fiber material sucked in by the suction mold also settles in the area of the connecting wall and projects through the apertures. This way, an excellent intimate bond between the connection element and the fiber material of the container may be achieved. The connecting wall may surround the opening so that the form-fitting connection is achieved along the entire circumference of the opening.

The invention further relates to a method of manufacturing a receptacle comprising a container having at least one opening and a lid for closing the opening, the lid being connected to the container by an elastically deformable hinge. The method comprises the following method steps:
sucking fiber material from a pulp through a suction mold and compacting the fiber material deposited on the inner wall of the suction mold to form the container;
dewatering and drying of the container;
coating of the container;
injection molding of the lid from biodegradable thermoplastic material;
fastening the lid to a flexible hinge strip made of fiber material;
bonding the hinge strip to the container.

This way, the various components of the receptacle can be manufactured and joined together efficiently and cost-effectively.

In practice, the connection element made of biodegradable thermoplastic material may be arranged on the container in the area of the opening, with the hinge strip being bonded to the container in the area of the connection element.

The lid and the connection element made of thermoplastic material may form a snap connection or snap-in connection with which the receptacle can be closed. In the open state, the lid is connected to the connection element via the hinge strip.

As mentioned further above, the hinge strip may be bonded to the lid.

Further, the hinge strip may include at least a second section bonded to the container, namely a seal section, which is perforated and separated along the perforation when the lid is opened. In this manner, the hinge strip forms a tamper-evident seal.

Finally, the container may have an external thread in the region of the opening and the lid may have an internal thread that can be screwed onto the external thread, the lid being rotatably connected to the hinge strip.

### BRIEF DESCRIPTION OF DRAWINGS

Further practical embodiments and advantages of the invention are described below in connection with the drawings.

FIG. 1 shows a side exploded view of a receptacle according to the invention.

FIG. 2 shows a three-dimensional exploded view of the receptacle of FIG. 1 from above.

FIG. 3 shows the front view of the receptacle of FIGS. 1 and 2.

FIG. 4 shows the view of the receptacle of FIG. 3 cut along section line IV-IV.

FIG. 5 shows another embodiment of the hinge strip for the receptacle.

FIG. 6 shows a front view of the receptacle with the hinge strip of FIG. 5.

FIG. 7 shows a side view of the receptacle with the hinge strip of FIG. 5.

FIG. 8 shows a view of the receptacle corresponding to FIG. 7 with the lid swung open.

FIG. 9 shows a bottom view of the lid of the receptacle with a further embodiment of the hinge strip.

FIG. 10 shows a sectional view corresponding to FIG. 4 of the receptacle with the hinge strip of FIG. 9.

FIG. 11 shows a view of the receptacle corresponding to FIG. 10 with the lid swung open.

### DESCRIPTION OF EMBODIMENTS

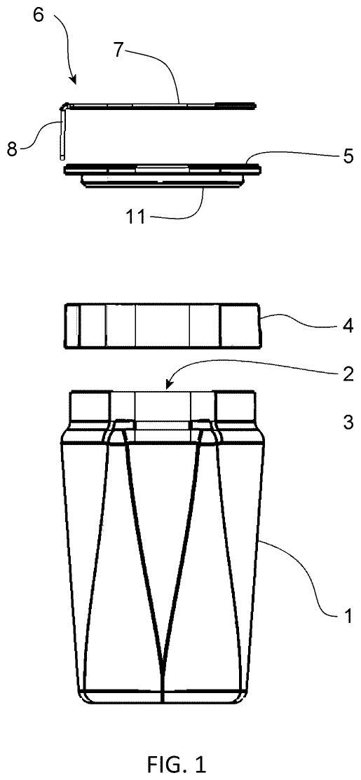

FIGS. 1 to 4 show a first embodiment of the receptacle. FIG. 1 shows an exploded view of the components of a receptacle used for packaging chewing gum. The receptacle is composed of a container 1, which consists of a hollow body made of molded fiber and open at the top. The opening 2 of the container 1 is surrounded by a rim 3 which extends substantially vertically upwards and is connected to a connection element 4. The connection element 4 is made of a biodegradable thermoplastic, in particular a starch-based thermoplastic having the constituents described at the beginning. This connection element 4 of thermoplastic may be made by injection molding and connected substantially tightly to the rim 3 of the container 1. The connection element 4 can be closed with a lid 5, which is also made from a biodegradable thermoplastic by injection molding.

In common plastic containers, such injection-molded parts as the connection element 4 and the lid 5 are pivotably connected to each other by means of a film hinge, which is made of the same thermoplastic. However, the biodegradable starch-based thermoplastic usually has too little elasticity to reliably form a film hinge between lid 5 and connection element 4. For this reason, a flexible hinge strip 6 made of paper, in particular kraft paper, is provided which pivotally connects the lid 5 to the container 1 and in particular to the connection element 4 of the container 1. The hinge strip 6 has a main section 7 extending parallel to the upper side of the lid 5 in FIG. 1 and bonded to the upper side of the lid 5. In FIG. 1 on the left side, a lateral section 8 of the hinge strip 6 can be seen which is angled downward at a right angle. This lateral section 8 is bonded to the connection element 4 of the container 1.

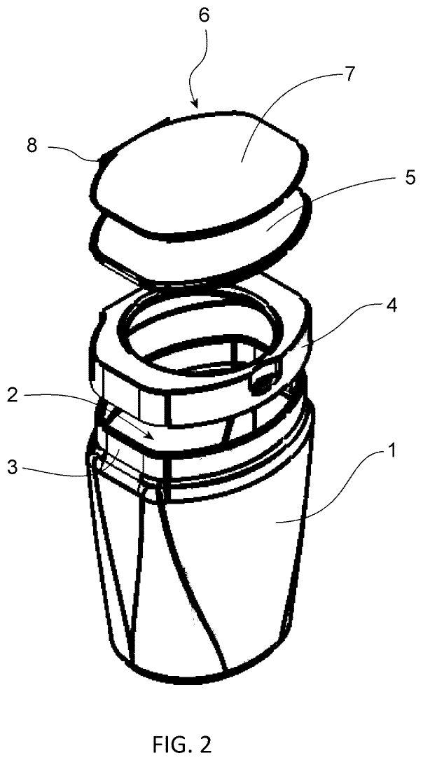

In FIG. 2, it can be seen that the width of the main section 7 of the hinge strip 6 is greater than the width of the lateral section 8. The main section 7 of the hinge strip 6 has a contour corresponding to the upper side of the lid 5 and is bonded to the upper side of the lid 5. The biodegradable thermoplastic may be water-soluble or alcohol-soluble. In this case, the main section 7 of the hinge strip 6 can be bonded by solvating the upper side of the lid 5 and then drying the upper side of the lid 5. In the same way, the inner side of the annular connection element 4 may be bonded to the rim 3 of the container 1. The outer side of the connection element 4 may be bonded to the lateral section 8 of the hinge strip 6.

Alternatively, a glue or other suitable biodegradable adhesive may be used to bond the hinge strip 6 to the lid 5 and the connection element 4.

The hinged connection between the lid 5 and the connection element 4 is essentially provided by the strip-shaped lateral section 8 of the hinge strip 6. If the main section 7 of the hinge strip 6 covers the entire surface of the lid 5, the hinge strip 6 can be printed and reproduce the product information. However, it is also possible that the main section 7 of the hinge strip 6 does not extend over the entire upper side of the lid 5.

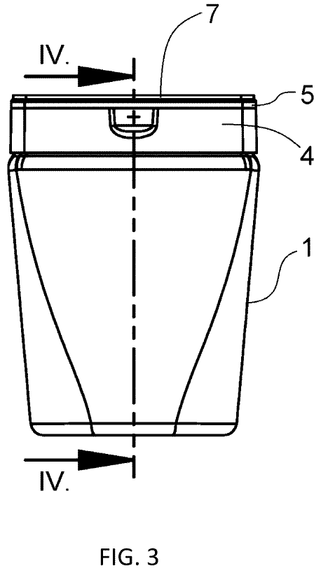

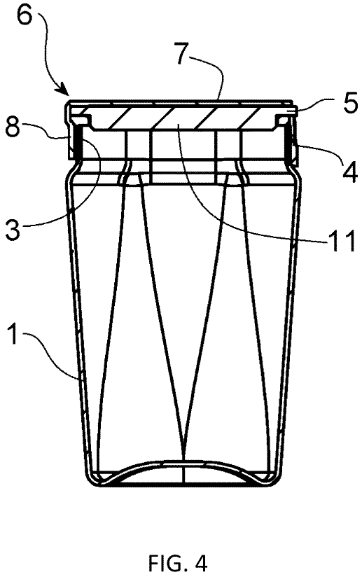

FIGS. 3 and 4 show a front view and a sectional side view, respectively, of the receptacle of FIGS. 1 and 2. It can be seen that the lid 5 has a flat periphery and a downwardly projecting circular section 11 in the center. The circular section 11 of the lid 5 may form a snap-in connection or snap connection with the inner circumference of the annular connection element 4. In particular in FIG. 4, it can be seen that the lateral section 8 of the hinge strip 6 is bonded to the outer side of the connection element 4. In this way, the lid 5 is securely held on the connection element 4 of the receptacle after opening.

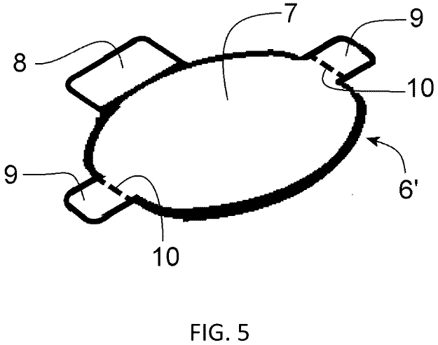

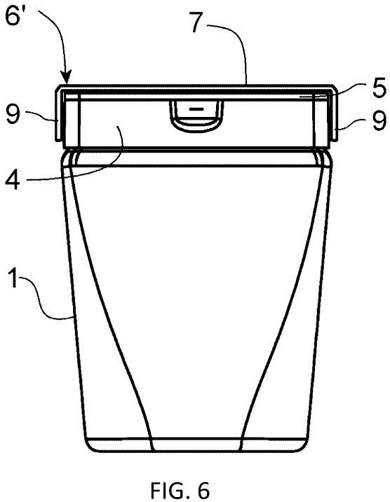

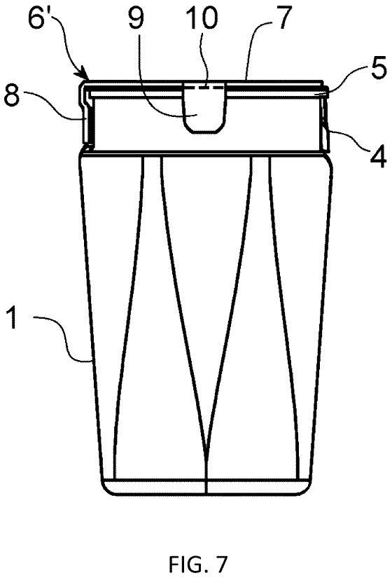

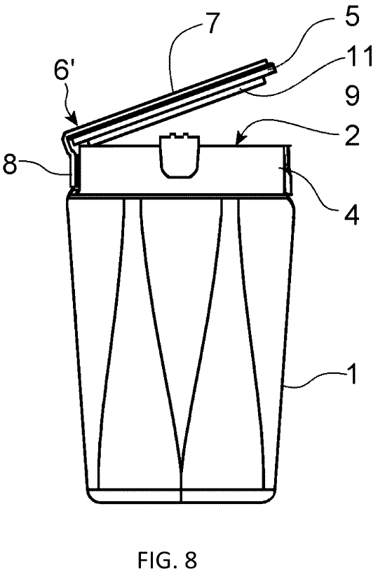

FIGS. 5 to 8 show a second embodiment of the hinge strip 6′. As in the previously described embodiment, the hinge strip 6′ has a main section 7 and a lateral section 8. The lateral section 8 is here still in the same plane as the main section 7 and is not bent by 90° as in FIG. 1. The hinge strip 6′ has two lateral seal sections 9 which are connected via a perforation 10, i.e., a line along which the connection between the seal section 9 and the main section 7 is partially severed. As can be seen in FIGS. 6 and 7, the seal sections 9 are bonded to the container 1 in the area of the side of the container 1 with its connection element 4. When the lid 5 is opened, the seal sections 9 separate from the main section 7 of the hinge strip 6 along the perforation 10. This can be seen in FIG. 8, which shows the lid 5 swung open. Thus, the seal strips 9 represent tamper-evident seals, by means of which it can be seen that the receptacle has been opened.

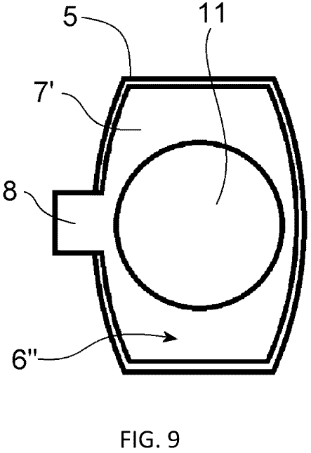

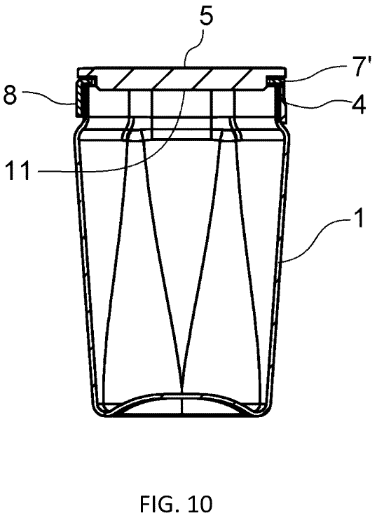

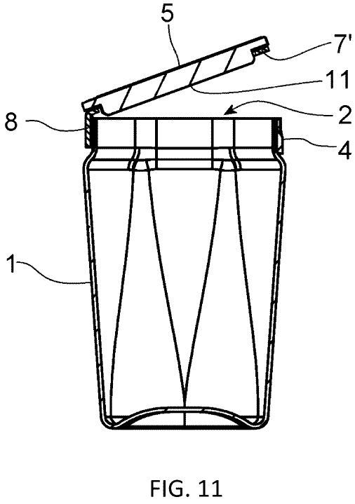

FIG. 9 shows a bottom view of the lid 5 with a further embodiment of the hinge strip 6″. The main section 7′ of the hinge strip 6″ has the shape of an eyelet, i.e. it has a circular aperture in its center through which the circular projection of the lid 5 extends. The main section 7 of the hinge strip 6″ is thus bonded against the surface of the lid 5 facing downwards when the receptacle is closed ([FIG. 10]), while its lateral section 8 continues to be bonded against the upper rim of the container 1. The hinge strip 6″ holds the open lid 5 shown in FIG. 11 tight on the container 1.

If the lid has a screw thread (not shown) which can be screwed to the connection element, bonding between the hinge strip 6″ and the lid 5 can be dispensed with. In this case, the projecting circular section 11 of the lid 5 can have a groove or slot on its circumference into which the ring-shaped or eyelet-shaped main section of the hinge strip fits. The lid 5 is thus rotatably connected to the hinge strips 6″.

The features of the invention disclosed in the present description, in the drawings as well as in the claims may be essential, both individually and in any combination, for the realization of the invention in its various embodiments. The invention is not limited to the embodiments described. It may be varied within the scope of the claims and with due regard to the knowledge of the relevant person skilled in the art.

### REFERENCE SIGNS LIST

1 container
2 opening
3 rim
4 connection element
5 lid
6,6′,6″ hinge strip
7,7′ main section
8 lateral section
9 seal section
10 perforation
11 circular section

The invention claimed is:

1. A fiber container comprising:
at least one opening;
at least one lid operable to close the at least one opening; and
at least one flexible hinge strip;
wherein the container is made of fiber material and includes a biodegradable or bioinert coating;
wherein the at least one lid is connected to the container by the at least one flexible hinge strip;
wherein the at least one lid is made of biodegradable thermoplastic material;
wherein the at least one flexible hinge strip is made of fiber material;
wherein the at least one flexible hinge strip is attached to the at least one lid; and
wherein the at least one flexible hinge strip is connected to the container.

2. The fiber container of claim 1, wherein the container further includes at least one connection element made of biodegradable thermoplastic material in the area of the at least one opening, wherein the at least one flexible hinge strip is connected to the container by the at least one connection element).

3. The fiber container of claim 1, wherein the at least one flexible hinge strip is bonded to the at least one lid.

4. The fiber container of claim 1, wherein the at least one flexible hinge strip includes at least one seal section, wherein the at least one seal section is connected to the container, and wherein the at least one seal section is perforated and separated along a perforation when the at least one lid is opened.

5. The fiber container of claim 1, wherein the container further includes at least one external thread in the area of the at least one opening, wherein the at least one lid further includes at least one internal thread, wherein the at least one internal thread of the at least one lid is operable to be screwed onto the at least one external thread of the at least one opening, wherein the at least one lid is rotatably connected to the at least one flexible hinge strip.

6. The fiber container of claim 1, wherein the at least one flexible hinge strip further includes at least one eyelet, wherein a section of the at least one lid further includes a circular cross-section, wherein the circular cross-section of the at least one lid extends through the at least one eyelet of the at least one flexible hinge strip.

7. The fiber container of claim 1, wherein the biodegradable or bioinert coating includes cellulose fibers, casein, whey, agar agar, psyllium husks, SiO₂, linseed oil, carnauba wax, and/or beeswax.

8. The fiber container of claim 1, wherein the biodegradable thermoplastic material of the at least one lid and/or of the at least one connection element is water-soluble and/or compostable.

9. The fiber container of claim 1, wherein the at least one connection element is connected to the container by substance bonding and/or form-fitting.

10. The fiber container of claim 9, wherein the at least one connection element includes a connecting wall surrounding the at least one opening and a plurality of holes through which the fiber material of the container extends.

11. A method for producing a molded fiber container including at least one opening and at least one lid operable to close the at least one opening, wherein the at least one lid is connected to the container by at least one flexible hinge strip, wherein producing the fiber container includes:
sucking a fiber material from a pulp through a suction mold, wherein the fiber material is deposited on an inner wall of the suction mold;
compacting the fiber material deposited on the inner wall of the suction mold to form the container;
dewatering and drying the container;
coating the container in a biodegradable or bioinert coating;
forming the at least one lid by injection molding, wherein the at least one lid is made of biodegradable thermoplastic material;
fastening the at least one lid to the at least one flexible hinge strip, wherein the at least one flexible hinge strip is made of fiber material; and
connecting the at least one flexible hinge strip to the container.

12. The method of claim 11, further comprising arranging at least one connection element made of biodegradable thermoplastic material on the container in the area of the at least one opening, further comprising bonding the at least one flexible hinge strip is to the container in the area of the at least one connection element.

13. The method of claim 11, further comprising bonding the at least one flexible hinge strip to the at least one lid.

14. The method of claim 11, wherein the at least one flexible hinge strip comprises includes at least one seal section connected to the container, wherein the at least one seal section is perforated and separated along a perforation when the at least one lid is opened.

15. The method of claim 11, wherein the container includes at least one external thread in the area of the at least one opening, wherein the at least one lid includes at least one internal thread, wherein the at least one internal thread on the at least one lid is screwed onto the at least one external thread of the at least one opening, wherein the at least one lid is rotatably connected to the at least one flexible hinge strip.

16. The fiber container of claim 1, wherein the at least one flexible hinge strip is connected to the container by bonding.

17. The method of claim 11, wherein connecting the at least one flexible hinge to the container includes bonding the at least one flexible hinge strip to the container.

18. A biodegradable molded fiber container comprising:
at least one lid;
a body including at least one opening;
at least one flexible hinge strip including a main section and a lateral section;
at least one connection element; and
a biodegradable or bioinert coating;
wherein the container is molded from biodegradable fiber material;
wherein the at least one lid is made of biodegradable thermoplastic material;
wherein the at least one flexible hinge strip is made of biodegradable fiber material;
wherein the at least one connection element is made of biodegradable thermoplastic material;
wherein the at least one connection element is connected to the body of the container;
wherein the at least one connection element is connected to the at least one lid by the at least one flexible hinge strip;
wherein the main section of the at least one flexible hinge strip is connected to the at least one lid;
wherein the lateral section of the at least one flexible hinge strip is connected to the at least one connection element;
wherein the at least one flexible hinge strip facilitates opening or closing the at least one lid; and
wherein the at least one connection element is operable to stabilize the at least one opening.

19. The biodegradable molded fiber container of claim 18, wherein a circular projection of the at least one lid is operable to fit into an annular opening of the at least one connection element, wherein the at least one lid is operable to close the at least one opening by a snap-fit connection with the at least one connection element.

20. The biodegradable molded fiber container of claim 18, wherein the at least one opening includes at least one external thread and the at least one lid includes at least one internal thread, wherein the at least one internal thread is operable to be screwed onto the external thread providing for the at least one flexible hinge strip to be rotatably connected to the at least one lid.
